(19) United States
(12) Patent Application Publication
(10) Pub. No.: US 2021/0304100 A1
(43) Pub. Date: Sep. 30, 2021

(54) AUTOMATICALLY ALLOCATING NETWORK INFRASTRUCTURE RESOURCE COSTS WITH BUSINESS SERVICES

(71) Applicant: Harness Inc., San Francisco, CA (US)

(72) Inventors: Puneet Saraswat, San Francisco, CA (US); Rishikesh Singh, Sunnyvale, CA (US); Vikas Naiyar, San Francisco, CA (US); Soma Bhakta, San Francisco, CA (US); Hitesh Aringa, San Francisco, CA (US)

(73) Assignee: Harness Inc., San Francisco, CA (US)

(21) Appl. No.: 16/831,811

(22) Filed: Mar. 27, 2020

(51) Int. Cl. G06Q 10/06; G06Q 30/02

(52) U.S. Cl. CPC G06Q 10/06315; G06Q 30/0283

(57) ABSTRACT

A system automatically allocates network infrastructure resource costs with business services. The present system continuously monitors the software system to detect events and pricing data for a software system. The system then allocates network infrastructure resource costs with business services based on the detected event data and pricing data. In some instances, the cost for a resource for a business service is determined based on the percentage of overall resource usage that is allocated to the particular business service. The allocated amounts can be added to running totals and aggregated for extended periods.

### BACKGROUND

A major shift in the software industry exists where the majority of new software is built for and deployed on public cloud providers—providers that provide on-demand availability of computer system resources, such as for example data storage and computing power, over a network such as the Internet and without direct active management by a user. Cloud providers typically charge their customers for the services used on a monthly basis, and provide a breakdown of the costs generated by such services which are specific to the particular cloud provider. For example, one cloud provider bill may provide a cost breakdown across provider accounts, regions, and so forth, while another provider may provide a cost breakdown based on projects, regions, and products. This cost breakdown does not directly correspond to business specific functions of companies that use these services.

As a result, businesses that need to allocate their costs to the microservices, teams and business units who own them, for example to provide incentives for teams and owners to optimize and budget their costs, have great difficulty allocating such costs. What is needed is an improved method for allocating cloud provider costs actual business services.

### SUMMARY

The present technology, roughly described, automatically allocates network infrastructure resource costs with business services. The present system continuously monitors the software system to detect events, pricing data, performance, service degradation, and other aspects of the software system. The events may include the start and stop times of resource usage for a particular business service and other data that may be expressed as time series data. The pricing data can include pricing rates over a period of time.

The present system then allocates network infrastructure resource costs with business services based on the detected event data, pricing data, and a list of business services for which the pricing should be determined. In some instances, the cost for a resource for a business service is determined based on the percentage of overall resource usage that is allocated to the particular business service. An idle time for a resource used for a business service can be determined in a similar way using event data and pricing data. Once the allocated cost, idle time, and trend time are calculated for a period of time, for example an hour, the allocated amounts can be added to running totals and aggregated for extended periods, such as for example hours, days, weeks, months, quarters, and so forth. The data and calculations can be reported to a user, for example through a dashboard with graphical, metric, and other elements.

In some instances, a method for automatically allocating resource costs to business services receives event data by application server. The event data can be received from one or more delegates installed in one or more computing resources. The event data can include business service specific resource events. Pricing data can be received for usage of the one or more computing resources. The application server can calculate a cost for usage of one of the one or more computing resources. The calculated cost can be associated with one business service of a plurality of business services. The cost of the usage, for the computing resource and the business service, is reported to a customer.

In some instances, a non-transitory computer readable storage medium has embodied thereon a program. The program is executable by a processor to perform a method for automatically allocating resource costs to business services. The method includes receiving event data by application server. The event data can be received from one or more delegates installed in one or more computing resources. The event data can include business service specific resource events. Pricing data can be received for usage of the one or more computing resources. The application server can calculate a cost for usage of one of the one or more computing resources. The calculated cost can be associated with one business service of a plurality of business services. The cost of the usage, for the computing resource and the business service, is reported to a customer.

A system for automatically allocating resource costs to business services includes a server. The server and one or more modules. The server includes a memory and a processor, where the one or more modules are stored in memory and executable by the processor. The modules are executable to receive event data from one or more delegates installed in one or more computing resources, the event data including business service specific resource events, receive pricing data for usage of the one or more computing resources, calculate a cost for usage of one of the one or more computing resources, the calculated cost associated with one business service of a plurality of business services, and report the cost of the usage for the computing resource for the business service to a customer.

### BRIEF DESCRIPTION OF FIGURES

FIG. 1 is a block diagram of a system for automatically allocating network infrastructure resource cost with business services.

FIG. 2 is a block diagram of a continuous monitoring system.

FIG. 3 is a block diagram of a batch processor.

FIG. 4 is a method for automatically allocating network infrastructure resource costs with business services.

FIG. 5 is a method for collecting data by delegates in customer environments.

FIG. 6 is a method for determining custom usage with infrastructure costs per business service.

FIG. 7 is a method for determining custom resource waste or business service and infrastructure cost.

FIG. 8 is a method for optimizing resource usage.

FIG. 9 is a dashboard for communicating automatically allocated network infrastructure resource costs.

FIG. 10 is a block diagram of a computing environment for implement in the present technology.

### DETAILED DESCRIPTION

The present technology, roughly described, automatically allocates network infrastructure resource costs with business services. A software system that is implemented at least partially “in the cloud,” that is over a network using computing resources provided and physically maintained by a computing services provider (i.e., “cloud provider”), is monitored continuously by the present system.

For companies using these cloud providers, the cost of cloud computing resources is a key component of their expenditures. From a business perspective, one challenge is to allocate this cloud cost into business specific functions for accounting purposes. For example, the cost for cloud resources which are used to serve end customers should be categorized as COGS [Cost of Goods Sold], while the resources which are used for development and/or test flows should be categorized as research and development expenses.

The present system continuously monitors the software system to detect events, pricing data, performance, service degradation, and other aspects of the software system. The events may include the start and stop times of resource usage for a particular business service and other data that may be expressed as time series data. The pricing data can include pricing rates over a period of time.

The present system then allocates network infrastructure resource costs with business services based on the detected event data, pricing data, and a list of business services for which the pricing should be determined. In some instances, the cost for a resource for a business service is determined based on the percentage of overall resource usage that is allocated to the particular business service. An idle time for a resource used for a business service can be determined in a similar way using event data and pricing data. Once the allocated cost, idle time, and trend time are calculated for a period of time, for example an hour, the allocated amounts can be added to running totals and aggregated for extended periods, such as for example hours, days, weeks, months, quarters, and so forth. The data and calculations can be reported to a user, for example through a dashboard with graphical, metric, and other elements.

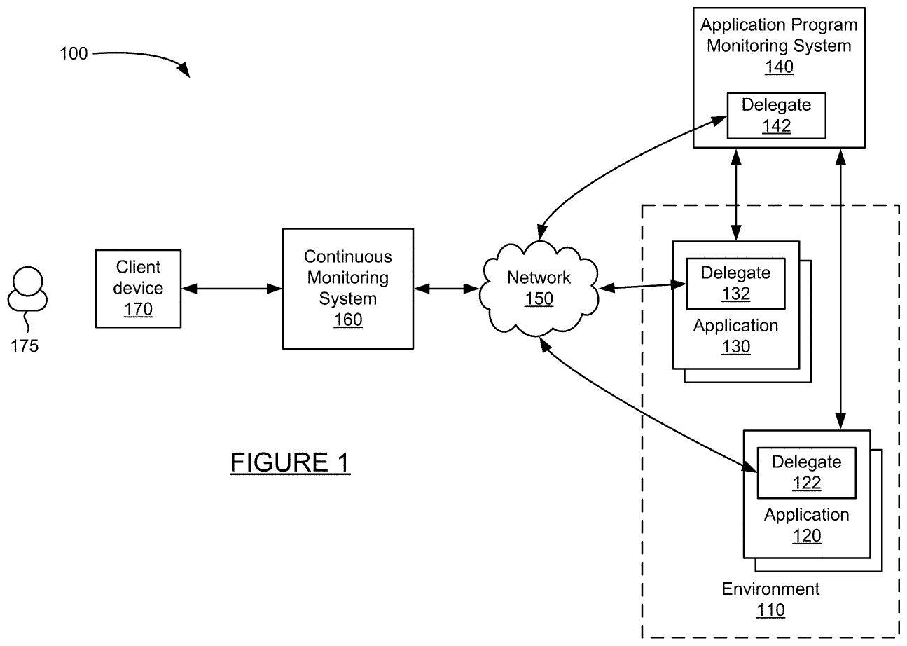

FIG. 1 is a block diagram of a system for automatically allocating network infrastructure resource cost with business services. System 100 of FIG. 1 includes environment 110, application program monitoring system 140, network 150, continuous monitoring system 160, and client device 170. Environment 100 may include one or more applications, such as for example application 120 and application 130, maintained and executed from one or more cloud computing services. Examples of cloud computing services can include Amazon Web services, Google Computing Platform, Microsoft Azure, and other cloud computing services. Thought only one environment is illustrated, multiple environments, each with one or more cloud computing services, may be used within the present system.

Network 150 may include one or more private networks, public networks, intranets, the Internet, an intranet, wide-area networks, local area networks, cellular networks, radio-frequency networks, Wi-Fi networks, any other network which may be used to transmit data, and any combination of these networks.

Continuous monitoring system 160 may continuously detect service performance, events, trends, and so forth, in the performance or behavior of one or more applications within environment 110 in real-time, for example before or after a software update is delivered to an application. To detect service regression, monitoring system 160 may monitor the applications either directly through delegates installed on the applications themselves, such as delegates 122, 132, and 142, or by access to real-time streaming monitoring data (including metrics or other data) provided by application program monitoring system 140.

A delegate may include an agent or other code that is installed to an application or system (e.g., host) and can communicate with remote systems and applications such as continuous monitoring system 160. Each delegate may receive instructions and tasks from monitoring system 160, retrieve information and transmit the information periodically or based on other events to monitoring system 160, may install new code or update code on an application or system, and perform other tasks and operations. In some instances, delegates may be installed on an application program monitoring system, such as a monitoring system provided by AppDynamics, Inc., of San Francisco Calif., to retrieve and transmit a stream of application performance metrics to delivery monitoring system 160. In some instances, delegates may be provided on one or more servers of an environment 120, such as servers hosting application 130 and application 136, to monitor applications and servers that include new code and those that did not host any new code (e.g., control servers).

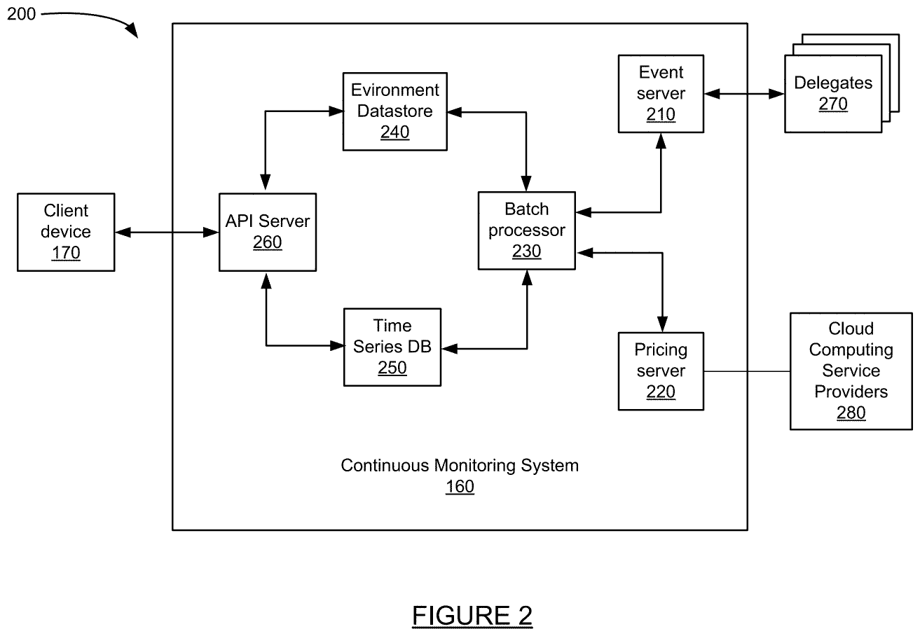

Continuous monitoring system 160 may provide continuous monitoring and custom cost allocation for a system. The continuous monitoring system can determine if there are any immediate or near-term issues, such as performance regression, and may provide reports and alerts based on the determination(s). The continuous monitoring system 160 may include a manager that manages tasks associated with the monitoring, utilization modules, clustering modules, a data store and other functionality. More details for a continuous monitoring system are discussed with respect to FIG. 2.

As monitoring system 160 provides continuous delivery and monitoring of new code, it may provide updates, alerts, notifications, and other information through one or more user interfaces to a user 194. The continuous monitoring system 160 can receive application data from delegates 122, 132, and 142 within cloud service providers to obtain event data, as well as communicate with cloud computing service provider applications (e.g., application program interfaces, or APIs) to obtain pricing data. The event data and pricing data can be used with business service data to determine infrastructure costs and waste for micro-services such as business services. Continuous monitoring system is discussed in more detail with respect to FIG. 2.

Client device 195 may be implemented as any computer that can receive and provide reports, such as for example through a user interface or dashboard, via a network browser on a mobile device, smart phone, tablet, or any other computing machine. Reporting the status and results of continuous delivery service monitoring and automatically allocating network infrastructure resource costs with business services is discussed in more detail herein.

FIG. 2 is a block diagram of a continuous monitoring system. Continuous monitoring system of FIG. 2 provides more detail for continuous monitoring system 160 of the block diagram of FIG. 1. Continuous monitoring system 160 of FIG. 2 includes event server 210, pricing server 220, batch processor 230, environment datastore 240, time series database 250, and API server 260. Event server 210 may receive data from a plurality of delegates 260. The delegates 260 can include delegates 142, 132, and 122 of block diagram 100 of FIG. 1. The delegates detect events and report the events to event server 210. Event server 210 then provides the event data to best processor 230.

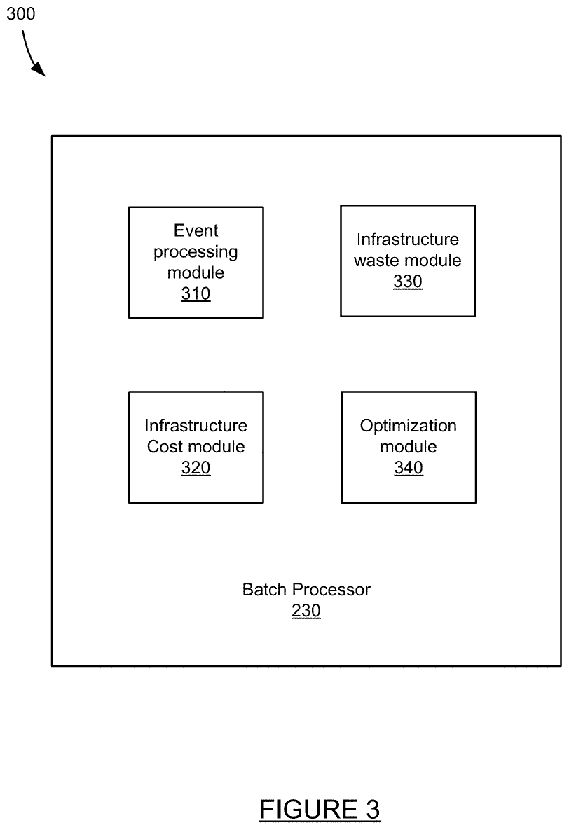

Batch processor 230 may receive event data and other data related to executing environments from event server 210. Batch processor may correlate and aggregate data and provide the data to environment data store 240 and time series database 250. Batch processor 250 is described in more detail with respect to FIG. 3.

The cloud computing service providers each have their own pricing information and schedules. The pricing information relates to costs for products and services provided by each particular cloud computing service. Pricing server 220 may retrieve costs for the products provided by each cloud computing service and provide the data to batch processor 230.

Environment data store may include a list of environments associated with business services implemented by a client. The environments may include development operations, engineering, finance, and other environments. The environments and identification information for each environment is provided to batch processor 230, which can correlate the environments to a subset of the events received from event server 210. Batch processor 230 generates timeseries data for each combination of environments and infrastructure costs and provides timeseries data to timeseries data base 250.

API server 250 receives client business environments data from environment datastore 240 and the correlated data from timeseries database 250, and provides interface data to client device 170. The data may be provided to client device 170 as a content page, dashboard, or in some other format for display or other communication to a client.

FIG. 3 is a block diagram of a batch processor 230. Batch processor 230 of FIG. 3 provides more details for the batch processor of FIG. 2. Batch processor 230 may include a plurality of modules that perform operations and functionality discussed herein. The modules illustrated in FIG. 3 are intended to be exemplary, and are not intended to limit the functionality performed by a batch processor the present technology.

Batch processor 230 includes event processing module 310, infrastructure cost module 320, infrastructure waste module 330, and optimization module 340. Event processing module 310 receives event data from event server 210 and generates events from the event data. The events can be used to determine usage of infrastructure resources within particular environments. For example, the events may include a start time and stop time of usage for a virtual machine for a particular business service.

In some instances, different events may be detected for different cloud service providers, such as Kubernetes, Amazon Web Service, Microsoft Azure, Google Cloud Platform, and other services. For example, delegates may detect events such as the creation of a new deployment, a deployment autoscaling, pod container image update, service deployment, toggle of a feature flag, and other events. In some instances, for an Amazon Web Service, one or more delegates can detect events including but not limited to CloudWatch events (e.g., augmented AI events, auto-scaling events, batch events, and so forth), EC2 auto scaling events, EBS events, Config Events, EC2 state change events, and other events.

Infrastructure cost module 320 may receive pricing data from pricing server 220. The pricing data may be used to determine the cost of using a particular infrastructure resource for a cloud service provider. For example, pricing data can include an hourly cost of a virtual machine for a particular cloud service provider. In some instances, pricing data is retrieved for each service provider for which services or resources are used.

Infrastructure waste module 330 may process the received event data and pricing data to determine idle or non-usage of infrastructure resources and the cost of any idle resources. Optimization module 340 may process snapshots and trends of correlated infrastructure resources and business services to identify how to optimize use of a particular environment at the current time or in the future. For example, if three virtual machines are determined to be used only 10 minutes every hour by a particular application service, while a service provider is charging the client for three full hours for the three virtual machines, the optimization module 340 can determine that the number of virtual machines can be reduced to save costs, for example to two or one virtual machine for the particular application service.

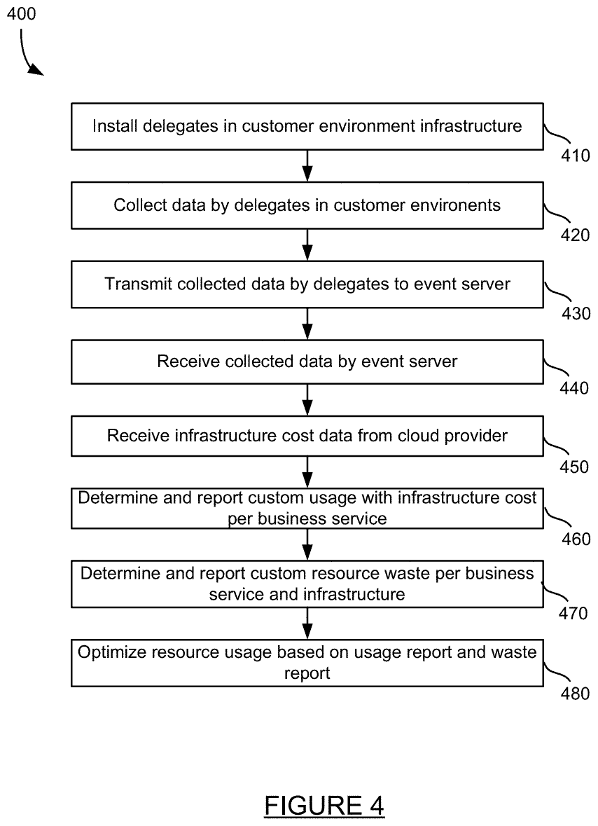

FIG. 4 is a method for automatically allocating network infrastructure resource costs with business services. First, delegates are installed in a customer environment infrastructure at step 410. Configuring an application with a delegate may include installing the delegate to the particular application (e.g., host) provided by a service provider. The application that receives the delegate is part of one or more customer environment infrastructure that includes all the applications used by the customer. The configuration may also include configuring the delegate with which data to capture, which managers (e.g., servers and applications) to communicate with, and other configuration tasks.

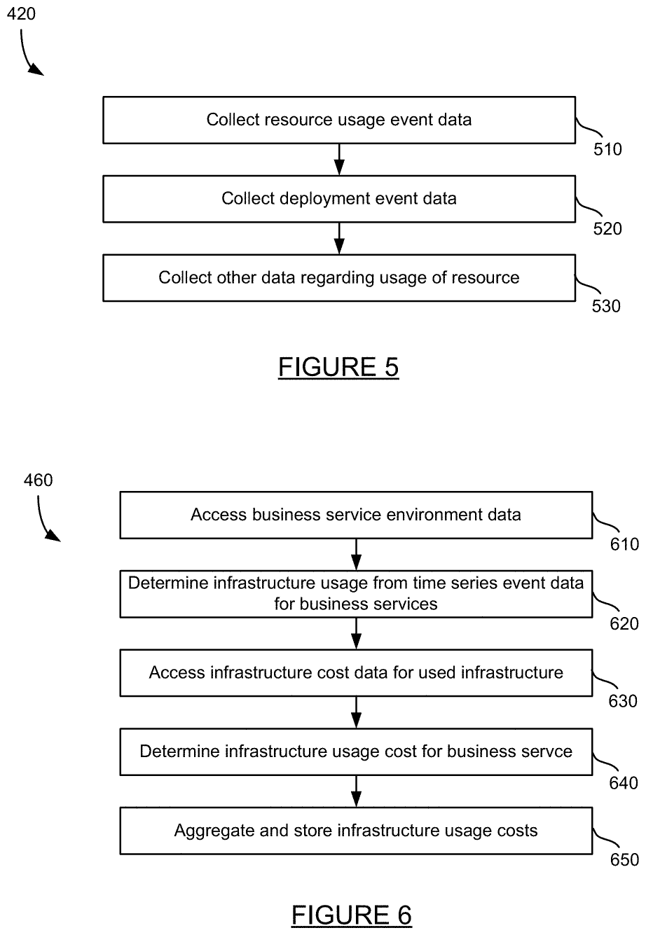

Data is collected by the delegates installed in the customer environments at step 420. The delegates may be installed in a plurality of environments, for example within one or more cloud computing services. More detail for step 420 is discussed with respect to the method of FIG. 5.

Collected event data is transmitted by delegates to an event server at step 430. The collected data is then received by the event server at step 440. Infrastructure cost data is received from one or more cloud providers by pricing server 220 at step 450. Infrastructure cost data may include pricing information for services subscribed to or purchased by the customer from a particular cloud provider.

Custom usage is determined as the infrastructure cost per business service at step 460. The custom usage is determined for each infrastructure component based on the cost per business service for the infrastructure. For example, the cost of using a particular virtual machine for development team or a login service can be determined. More details for determining the custom usage are discussed with respect to the method of FIG. 6.

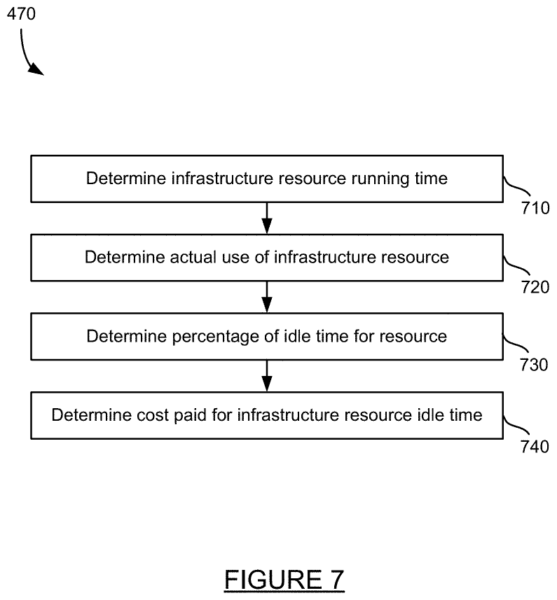

The custom resource waste is determined at step 470. In some instances, the custom resource waste is determined per business service and infrastructure. Once generated, the resource waste can be used to assist clients to identify resources that are paid for but not used. More detail for determining custom resource waste per business service and infrastructure is discussed with respect to the method of FIG. 7.

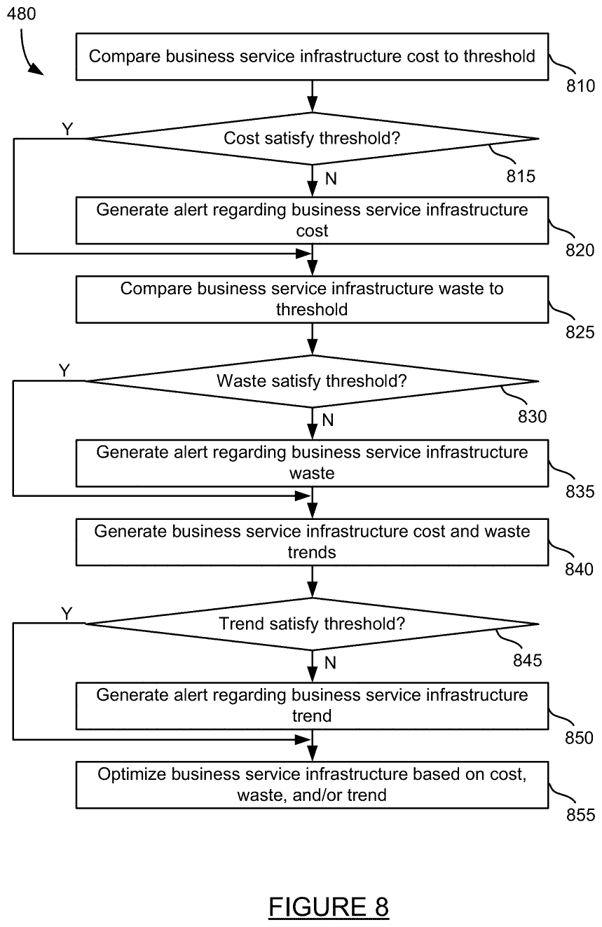

The resource usage is optimized at step 480. Once resource usage costs and waste are determined as discussed herein, resource usage can be optimized accordingly to meet expected usage and avoid detected waste. Additionally, resource usage trends can be determined, and resource usage can be optimized per the predicted trends. More details for optimizing resource usage based on a usage, waste, and trends are discussed with respect to the method of FIG. 8.

FIG. 5 is a method for collecting data by delegates in customer environments. The method of FIG. 5 provides more detail for step 420 the method of FIG. 4. First, resource usage event data is collected at step 510. Resource usage event data may include start and stop times for virtual machine usage, processing resources, and other resource events. Deployment event data can be collected at step 520. Deployment event data can include new deployments, and other events. Other data regarding the usage of a resource may be collected at step 530. The other data may include autoscaling events, state change events, and data for other events that relate to a service or resource obtained from a service provider.

FIG. 6 is a method for determining custom usage of infrastructure costs per business service. The method of FIG. 6 provides more detail for step 460 of the method of FIG. 4. First, business service environment data is accessed at step 610. The business service environment data is provided to batch processor 230 by environmental datastore 240. The service environment data can include a list of micro-services for which infrastructure cost should be allocated to. An exemplary list of microservices for which infrastructure costs can be allocated can include:
Checkout service
Login Service
Checkout service
Cart service
Payments Service
Recommendation service
User Profile service
Inventory Service
Authentication and Authorization Service
Reservations service
Order service

Infrastructure usage is determined from timeseries event data for a business service or services at step 620. For example, event data for a virtual machine may indicate the start time and stop time for each occurrence of a particular microservice, such as for example a checkout service. The start times and stop times that are contained within a particular period of time, such as for example an hour, for the virtual machine are summed. For example, a checkout service may have used a particular virtual machine for forty-eight minutes of an hour.

Infrastructure cost data may be accessed for used infrastructure at step 630. The infrastructure cost data can include the pricing data of the service provided by a cloud service provider. For example, a virtual machine pricing may cost $0.025 per hour.

Infrastructure usage costs may be determined for a business service at step 640. The infrastructure usage cost can be determined by multiplying the infrastructure usage cost (from step 620) by infrastructure cost data (from step 630) for a business service for which an infrastructure cost is to be determined (from step 610). For example, for a checkout service, the infrastructure usage cost can be determined as 48 minutes divided by 60 minutes (e.g., 0.8) multiplied by a cost of $0.025 per hour, for a cost of $0.02 for the particular hour in which the VM was used for 48 minutes for the checkout service. The infrastructure usage cost for a particular business service can be determined every hour or other period of time, for example based on the pricing structure (e.g., cost per hour, cost per minute, etc.)

Infrastructure usage costs may then be aggregated and stored at step 650. The costs may be aggregated per business service over different time periods. For example, the cost for infrastructure costs can be continuously calculated and aggregated for periods of hours, days, weeks, months, quarters, years, and so forth.

FIG. 7 is a method for determining custom resource waste allocated to the infrastructure cost of a business service. The method of FIG. 7 provides more detail for step 470 of the method of FIG. 4. Infrastructure resource running time is determined at step 710. The running time may include the deployment of the resource through the termination of the resource.

The actual use of an infrastructure resource is determined at step 720. The actual use may determine the time that the resource is actually computing something on behalf of a business service. For example, the actual use for a checkout service may include the actual time a virtual machine is actually spending computing cycles performing a checkout for a transaction.

The percentage of idle time is determined for the resource at step 730. The percentage of idle time may be determined as the running time minus the actual use time. The percentage of idle time can then be determined as the idle time divided by the resource running time (from step 710).

The cost paid for the infrastructure resource idle time is determined at step 740. The cost paid can be determined as the percentage of idle time cost multiplied by the allocated cost for the resource. For example, if a resource is idle for 15% of the running time, and the cost allocated for the for resource for an hour is $0.02, then the idle cost for that hour is $0.003. The idle costs can be aggregated into days, weeks, months, quarters, and so forth, similar to allocated infrastructure costs for business services.

FIG. 8 is a method for optimizing resource usage. The method of FIG. 8 provides more detail for step 480 the method of FIG. 4. First, business service infrastructure cost is compared to a cost threshold that step 810. The cost threshold may be set by a customer administrator, a system threshold, previous cost data, or some other source.

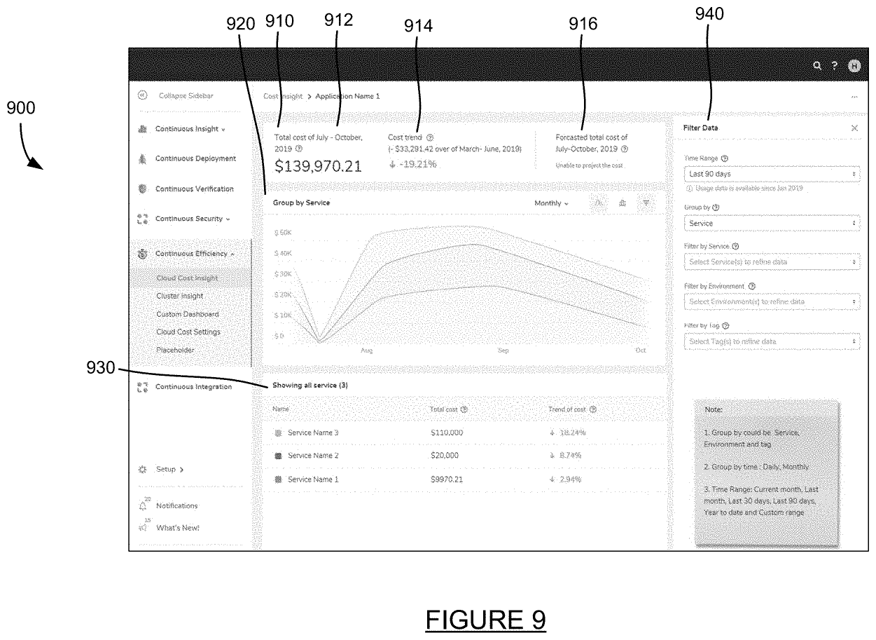

A determination is made as to whether the infrastructure cost satisfies the cost threshold at step 815. If the cost satisfies the threshold, FIG. 8 continues to step 825. If the cost does not satisfy the threshold, an alert is generated regarding the business service infrastructure costs at step 820. The alert may be provided to an administrator of the system, for example by messaging, email, or pager. In some instances, the alert may be communicated through a dashboard of an interface for communicating cost allocation for resources used for business services (e.g., the interface of FIG. 9).

In some instances, different degrees of exceeding the threshold may trigger different alerts. For example, a cost that exceeds a threshold by 5% may result in a dashboard alert while a cost that exceeds a threshold by 200% may result in a pager alert. After generating alerts at step 820, the method continues to step 825.

Business service infrastructure waste is compared to a threshold at step 825. A determination is then made as to whether the business service infrastructure waste satisfies a threshold at step 830. If the waste does satisfy the threshold, FIG. 8 continues to step 840. If the waste does not satisfy the threshold, the alert is generated regarding the business service infrastructure waste at step 835. Alerts may be provided via different mechanisms and in response to different levels of exceeding a threshold, similar to the alerts described with respect to business service infrastructure cost. After generating an alert at step 835, the method continues to step 840.

Business service infrastructure cost and waste trends are generated at step 840. A determination is made as to whether the trends satisfy a corresponding threshold at step 845. If the trends satisfy their corresponding threshold, the method continues to step 855. If one or both of the trends do not satisfy a corresponding threshold, an alert is generated regarding cost or waste trend at step 850. Alerts may be provided via different mechanisms and in response to different levels of exceeding a threshold, similar to the alerts described with respect to business service infrastructure cost. The method then continues to step 855.

Business service infrastructure is optimized based on cost, waste, and/or trends at step 855. In some instances, optimizing includes reducing excess resource usage, reducing excess idle time for resources, and planning resource usage to support predicted trends in upcoming usage. The optimization may be performed to ensure the system runs as smoothly as possible and maintains proper resource usage for the tracked business services.

FIG. 9 is an interface having a dashboard for communicating automatically allocated network infrastructure resource costs. The dashboard of interface 900 includes metric window 910, graphical window 920, service listing window 930, and filter data window 940. Metric window 910 can include cost and other metrics for a particular application. For example, for “Application name 1” currently selected, the total cost of resources from July to October is displayed as $139,970.21, a cost trend is illustrated as 19.21% decreasing (per the green down arrow), and a forecasted total cost of July through October 2019 can be provided.

In graphical window 920, services with the application are illustrated based on their cost per month. The cost ranges from $0 to $50 K, occurring during the months of August, September, and October. The three services illustrated in graphical window 920 each indicate a rising cost in August, a peak cost around September, and a decreasing cost in October.

In service listing window 930, the name, total cost, and trend of each cost is illustrated. For example, for the service named “Service name three,” the total cost for the service is $110,000 and a trend of the cost is 18.24% decreasing (green arrow pointing down).

In filter data window 940, filter options of time range, group by, service, environment, and tag are illustrated. Also illustrated within the interface 900 is a sidebar for selecting cloud costs and other data.

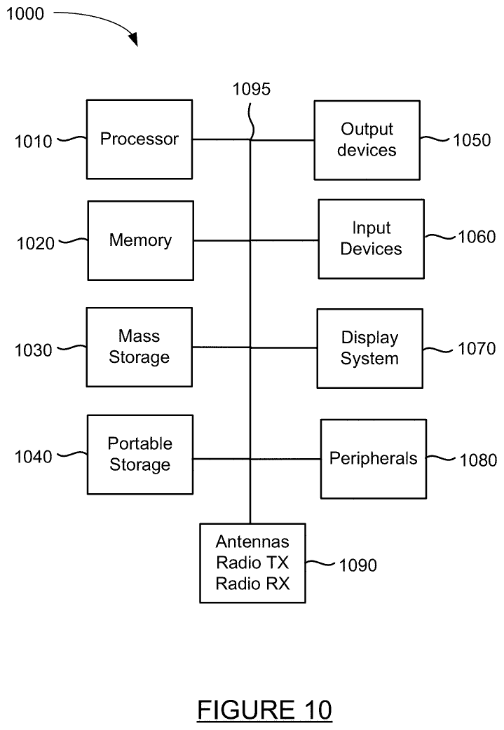

FIG. 10 is a block diagram of a computing environment for implement in the present technology.

FIG. 10 is a block diagram of a system for implementing machines that implement the present technology. System 1000 of FIG. 10 may be implemented in the contexts of the likes of machines that implement application program monitoring system 140, machines that host applications 120 and 130, continuous monitoring system 160, and machines that provide resources for cloud computing service providers 280. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive, an optical disk drive, a flash drive, or other device, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a floppy disk, compact disk or Digital video disc, USB drive, memory card or stick, or other portable or removable memory, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1000 as shown in FIG. 10 includes output devices 1050. Examples of suitable output devices include speakers, printers, network interfaces, and monitors.

Display system 1070 may include a liquid crystal display (LCD) or other suitable display device. Display system 1070 receives textual and graphical information and processes the information for output to the display device. Display system 1070 may also receive input as a touch-screen.

Peripherals 1080 may include any type of computer support device to add additional functionality to the computer system. For example, peripheral device(s) 1080 may include a modem or a router, printer, and other device.

The system of 1000 may also include, in some implementations, antennas, radio transmitters and radio receivers 1090. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically allocating resource costs to business services; comprising:
receiving, by an application server, event data from one or more delegates installed in one or more computing resources, the event data including business service specific resource events;
receiving, by the application server, pricing data for usage of the one or more computing resources;
calculating, by the application server, a cost for usage of one of the one or more computing resources, the calculated cost associated with one business service of a plurality of business services; and
reporting the cost of the usage for the computing resource for the business service to a customer.

2. The method of claim 1, wherein the pricing data is a pricing rate for a period of time, and the cost is calculated as a percentage of use of the resource by the business service for the period of time.

3. The method of claim 1, wherein the event data is received by the application server as time series data.

4. The method of claim 1, further comprising receiving a list of business services for which to calculate a cost for usage of one of the one or more computing resources, the list of business services including a plurality of business services which each correspond to a subset of the received event data.

5. The method of claim 1, wherein the one or more resources are implemented and managed by a third party over a network.

6. The method of claim 1, further comprising calculating, by the application server, an idle time for resource usage for the business service.

7. The method of claim 1, further comprising:
aggregating the calculated cost for a period of time; and
reporting the aggregated calculated cost through a graphical interface.

8. A non-transitory computer readable storage medium having embodied thereon a program, the program being executable by a processor to perform a method for automatically allocating resource costs to business services, the method comprising:
receiving event data from one or more delegates installed in one or more computing resources, the event data including business service specific resource events;
receiving pricing data for usage of the one or more computing resources;
calculating a cost for usage of one of the one or more computing resources, the calculated cost associated with one business service of a plurality of business services; and
reporting the cost of the usage for the computing resource for the business service to a customer.

9. The non-transitory computer readable storage medium of claim 8, wherein the pricing data is a pricing rate for a period of time, and the cost is calculated as a percentage of use of the resource by the business service for the period of time.

10. The non-transitory computer readable storage medium of claim 8, wherein the event data is received by the application server as time series data.

11. The non-transitory computer readable storage medium of claim 8, the method further comprising receiving a list of business services for which to calculate a cost for usage of one of the one or more computing resources, the list of business services including a plurality of business services which each correspond to a subset of the received event data.

12. The non-transitory computer readable storage medium of claim 8, wherein the one or more resources are implemented and managed by a third party over a network.

13. The non-transitory computer readable storage medium of claim 8, the method further comprising calculating, by the application server, an idle time for resource usage for the business service.

14. The non-transitory computer readable storage medium of claim 8, the method further comprising:
aggregating the calculated cost for a period of time; and
reporting the aggregated calculated cost through a graphical interface.

15. A system for automatically allocating resource costs to business services, comprising:
a server including a memory and a processor; and
one or more modules stored in the memory and executed by the processor to receive event data from one or more delegates installed in one or more computing resources, the event data including business service specific resource events, receive pricing data for usage of the one or more computing resources, calculate a cost for usage of one of the one or more computing resources, the calculated cost associated with one business service of a plurality of business services, and report the cost of the usage for the computing resource for the business service to a customer.

16. The system of claim 15, wherein the pricing data is a pricing rate for a period of time, and the cost is calculated as a percentage of use of the resource by the business service for the period of time.

17. The system of claim 15, wherein the event data is received by the application server as time series data.

18. The system of claim 15, the modules further executable to receive a list of business services for which to calculate a cost for usage of one of the one or more computing resources, the list of business services including a plurality of business services which each correspond to a subset of the received event data.

19. The system of claim 15, wherein the one or more resources are implemented and managed by a third party over a network.

20. The system of claim 15, the modules further executable to calculate an idle time for resource usage for the business service.
